(19) United States
(12) Patent Application Publication
(10) Pub. No.: US 2015/0355917 A1
(43) Pub. Date: Dec. 10, 2015

(54) DATA PROCESSING APPARATUS AND COMMUNICATION SYSTEM

(71) Applicants: Tatsunori TSUJIMURA, (US); Toshio KOGA, (US); Masashi NOJIMA, (US); Makoto ITOI, (US); Daisuke TANIMOTO, (US); Hirohito NISHIYAMA, (US); Makoto ISODA, (US); Masuo ITO, (US)

(72) Inventors: Tatsunori TSUJIMURA, Tokyo (JP); Toshio KOGA, Tokyo (JP); Masashi NOJIMA, Tokyo (JP); Makoto ITOI, Tokyo (JP); Daisuke TANIMOTO, Tokyo (JP); Hirohito NISHIYAMA, Tokyo (JP); Makoto ISODA, Tokyo (JP); Masuo ITO, Tokyo (JP)

(73) Assignee: Mitsubishi Electric Corporation, Chiyoda-ku, Tokyo (JP)

(21) Appl. No.: 14/762,305

(22) PCT Filed: Mar. 1, 2013
(86) PCT No.: PCT/JP13/55655

§ 371 Date: Jul. 21, 2015

(51) Int. Cl. G06F 9/445; G06F 13/42

(52) U.S. Cl. CPC G06F 9/44505; G06F 13/4221

(57) ABSTRACT

A communication unit receives from a BCM output data which is data to I/O devices from the BCM. A shared memory stores the output data received by the communication unit. An anomaly detection communication processing unit and the communication unit generate a communication frame for anomaly detection to request sending the output data held in the BCM. The communication unit sends the communication frame for the anomaly detection to the BCM, and receives the output data held in the BCM from the BCM as a response to the communication frame for the anomaly detection. The anomaly detection checking unit compares the output data received from the BCM with the output data stored in the shared memory.

### TECHNICAL FIELD

The present invention relates to a communication system.

The present invention relates to, for instance, an in-vehicle network system using a multiplex transmission apparatus.

### BACKGROUND ART

In a body system, of an automobile, for controlling I/O (Input/Output) devices such as a head lamp, a wiper, and the like, in order to deal with the increasing quantity of wiring, an ECU (Electronic Control Unit) so-called BCM (Body Control Module) is used.

Further, in the body system, a plurality of multiplex transmission apparatuses, arranged at a plurality of locations of a vehicle, are used.

To each multiplex transmission apparatus, a plurality of I/O devices are connected.

Then, in the body system, the BCM and the plurality of multiplex transmission apparatuses are connected via a multiplex transmission route, thereby controlling the I/O devices.

On the other hand, in order to prevent a serious accident caused by occurrence of failure, the safety requirement for an in-vehicle network system has been increased more and more, and Functional Safety Standard for Road Vehicles, ISO 26262 is formulated.

In such a situation, one of problems of the automotive body system is to deal with a malfunction of the BCM due to an occurrence of failure.

In order to solve the problem, there is disclosed a technique to check the presence or absence of anomalous occurrence of the BCM based on the reception status of a communication frame from the BCM in the multiplex transmission apparatus (for instance, Patent Literatures 1, 2, and 3).

Further, there is disclosed another technique to check the presence or absence of anomalous occurrence by providing a counter value for the number of transmissions in a data area of the communication frame separately from the data for controlling the I/O device and by updating continuously the counter value (for instance, Patent Literature 4).

### CITATION LIST

### Patent Literature

Patent Literature 1: JP2004-017676A

Patent Literature 2: JP2002-158668A

Patent Literature 3: JP2006-135375A

Patent Literature 4: JP2000-156685A

### SUMMARY OF INVENTION

### Technical Problem

The technique disclosed in Patent Literatures 1, 2, and 3 enables anomaly detection for a function to send/receive the communication frame; however, there is a problem that the correctness of the data or calculation for controlling the I/O devices cannot be verified.

Further, the technique disclosed in Patent Literature 4 enables the anomaly detection for an incrementing process of the counter for the number of transmissions and configurational components related to the process; however, since the technique does not deal with data itself for controlling the I/O devices, there is a problem that the correctness of the data or calculation for controlling the I/O devices cannot be verified.

The present invention mainly aims to solve the above problems, and a main object of the present invention is to detect the anomaly of a route related to the control within the controller for controlling the devices.

### Solution to Problem

According to the present invention, a data processing apparatus included in a communication system having a controller, and a device controlled by the controller, the data processing apparatus includes:

a first communication unit which receives from the controller control data which is data from the controller to the device;

a storage unit which stores the control data received by the first communication unit;

a message generation unit which generates a transmission request message to request the controller to send the control data held in the controller, after the control data received by the first communication unit is stored in the storage unit;

a second communication unit which sends the transmission request message to the controller, and, as a response to the transmission request message, receives the control data held in the controller from the controller; and

a data comparison unit which compares the control data received by the second communication unit with the control data stored in the storage unit.

### Advantageous Effects of Invention

According to the present invention, the data processing apparatus receives control data held in the controller from the controller, and compares the received control data with the stored control data.

Therefore, anomaly of the route related to the control within the controller can be detected.

### BRIEF DESCRIPTION OF DRAWINGS

FIG. 1 is a diagram illustrating a configuration example of an in-vehicle network system related to a first embodiment.

FIG. 2 is a diagram illustrating a format of a communication frame of the in-vehicle network system related to the first embodiment.

FIG. 3 is a diagram illustrating an operation example of the in-vehicle network system related to the first embodiment.

FIG. 4 is a diagram illustrating the operation example of the in-vehicle network system related to the first embodiment.

FIG. 5 is a diagram illustrating a configuration example of an in-vehicle network system related to a second embodiment.

FIG. 6 is a diagram illustrating a format of a communication frame of the in-vehicle network system related to the second embodiment.

FIG. 7 is a diagram illustrating an operation example of the in-vehicle network system related to the second embodiment.

FIG. 8 is a diagram illustrating the operation example of the in-vehicle network system related to the second embodiment.

FIG. 9 is a diagram illustrating the operation example of the in-vehicle network system related to the second embodiment.

FIG. 10 is a diagram illustrating the operation example of the in-vehicle network system related to the second embodiment.

FIG. 11 is a diagram illustrating a hardware configuration example of a BCM and a multiplex transmission apparatus related to the first to third embodiments.

### DESCRIPTION OF EMBODIMENTS

### Embodiment 1

The present and subsequent embodiments will explain a configuration for an anomaly detection of a configurational component (for instance, a microcomputer or a CPU: Central Processing Unit) related to a control calculation inside a device connected to an in-vehicle network system.

Here, the contents that will be explained in the present and subsequent embodiments can be applied not limited to the in-vehicle network system, but to a communication system having a controller and a device controlled by the controller.

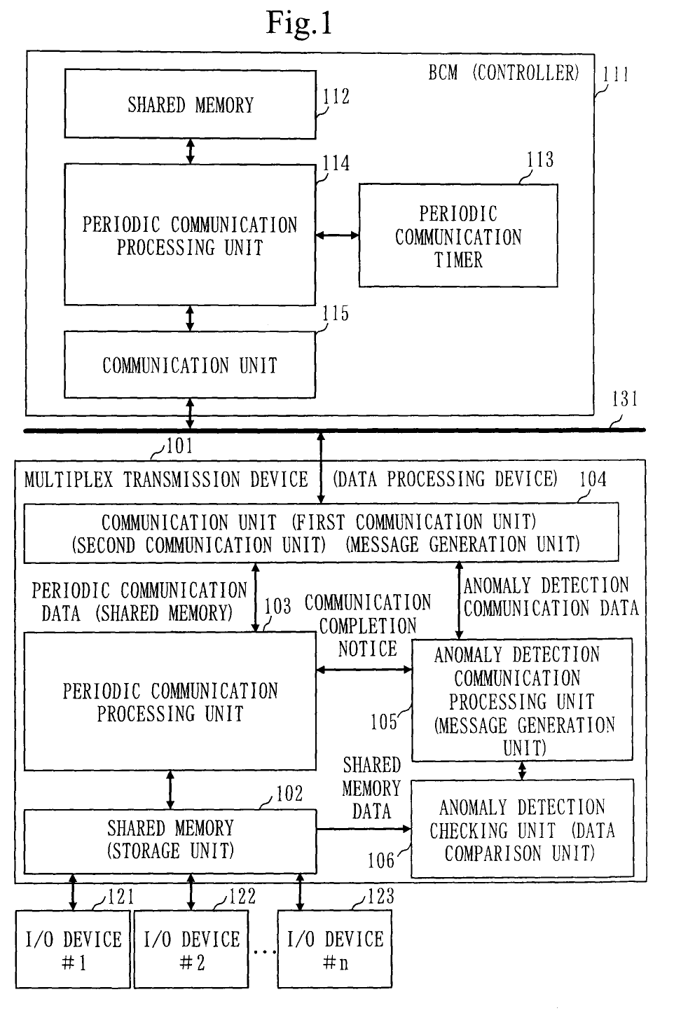

FIG. 1 is a diagram illustrating a configuration example of an in-vehicle network system related to a first embodiment.

As shown in FIG. 1, in the in-vehicle network system of the first embodiment, a BCM 111 and a multiplex transmission apparatus 101 connecting the I/O devices 121 to 123 are mutually connected via an in-vehicle network 131.

The in-vehicle network 131 is, for instance, a CAN (Control Area Network).

The BCM 111 corresponds to an example of a controller, I/O devices 121 to 123 correspond to an example of devices, and the multiplex transmission apparatus 101 corresponds to an example of a data processing apparatus.

In the present embodiment, from the BCM 111, the output data to the I/O devices 121 to 123 is sent to the multiplex transmission apparatus 101, and from the multiplex transmission apparatus 101, input data from the I/O devices 121 to 123 is sent to the BCM 111.

Then, the transmission of the output data from the BCM 111 to the multiplex transmission apparatus 101 and the transmission of the input data from the multiplex transmission apparatus 101 to the BCM 111 are treated as one processing sequence, and the processing sequence will be repeated.

Further, between the processing sequences, the BCM 111 and the multiplex transmission apparatus 101 carry out communication for detecting the anomaly of the BCM 111.

In the BCM 111, a shared memory 112 holds the output data to the I/O devices 121 to 123 and the input data from the I/O devices 121 to 123.

The output data corresponds to an example of the control data.

The input data corresponds to an example of the device data.

A periodic communication timer 113 supplies, with a constant cycle, a timing to send/receive data to a periodic communication processing unit 114, which will be discussed later.

Here, the cycle can be previously set in the periodic communication timer 113, or can be set to the periodic communication timer 113 from the storage device which is prepared separately, at the time of initialization of the BCM 111.

The periodic communication processing unit 114 sends, at a timing of the constant cycle generated by the periodic communication timer 113, the output data to the I/O devices 121 to 123 stored in the shared memory 112 via a communication unit 115 to the multiplex transmission apparatus 101, and further, receives the input data from the I/O devices 121 to 123 via the communication unit 115 from the multiplex transmission apparatus 101.

The communication unit 115 sends/receives data to/from the periodic communication processing unit 114 and the in-vehicle network 131.

More specifically, the communication unit 115 receives the output data to the I/O devices 121 to 123 from the periodic communication processing unit 114, and outputs the communication frame including the output data to the in-vehicle network 131.

Further, the communication unit 115 receives the communication frame including the input data from the I/O devices 121 to 123 from the in-vehicle network 131, and outputs the input data to the periodic communication processing unit 114.

Further, in the multiplex transmission apparatus 101, the shared memory 102 holds the output data to the I/O devices 121 to 123 and the input data from the I/O devices 121 to 123.

The output data corresponds to an example of the control data.

The input data corresponds to an example of the device data.

Further, the shared memory 102 corresponds to an example of a storage unit.

The periodic communication processing unit 103 receives the output data sent from the BCM 111 from the communication unit 104, which will be discussed later, and stores the output data in the shared memory 102.

Further, the periodic communication processing unit 103 reads out the input data written from the I/O devices 121 to 123 to the shared memory 102 from the shared memory 102, and outputs the input data to the communication unit 104.

The communication unit 104 sends/receives the data to/from the periodic communication processing unit 103 and the in-vehicle network 131.

More specifically, the communication unit 104 receives the communication frame including the output data to the I/O devices 121 to 123 from the in-vehicle network 131, and outputs the output data to the periodic communication processing unit 103.

Further, the communication unit 104 receives the input data from the I/O devices 121 to 123 from the periodic communication processing unit 103, and outputs the communication frame including the input data to the in-vehicle network 131.

In addition, the communication unit 104 generates the communication frame for the anomaly detection together with an anomaly detection communication processing unit 105, which will be discussed later, sends the communication frame for the anomaly detection to the in-vehicle network 131, and receives the communication frame for the anomaly detection from the BCM 111.

The communication unit 104 corresponds to an example of the first communication unit and the second communication unit.

Further, the communication unit 104 corresponds to an example of the message generation unit as well as the anomaly detection communication processing unit 105.

The anomaly detection communication processing unit 105 sends/receives to/from the BCM 111 via the communication unit 104 in order to detect the anomaly of the route related to the control of the BCM 111.

More specifically, the anomaly detection communication processing unit 105 generates the communication frame for the anomaly detection together with the communication unit 104, sends the communication frame for the anomaly detection via the communication unit 104 to the BCM 111, and receives the input data and the output data stored in the shared memory 112 from the BCM 111 via the communication unit 104.

The communication frame for the anomaly detection is the message to request for the transmission of the input data and the output data stored in the shared memory 112, and corresponds to an example of the transmission request message.

Further, the anomaly detection communication processing unit 105 corresponds to an example of the message generation unit as well as the communication unit 104.

The anomaly detection checking unit 106 compares the input data and the output data sent from the BCM 111 for the anomaly detection with the input data and the output data stored in the shared memory 102, and detects the anomaly of the route related to the control of the BCM 11.

The anomaly of the route related to the control inside the BCM 111 means the anomaly on the route of such as the CPU, the storage device, the communication bus, and the like on which the BCM 111 operates or accesses for the control.

The anomaly detection checking unit 106 corresponds to an example of the data comparison unit.

Next, an example of format of the communication frame used in the in-vehicle network system of the first embodiment will be explained.

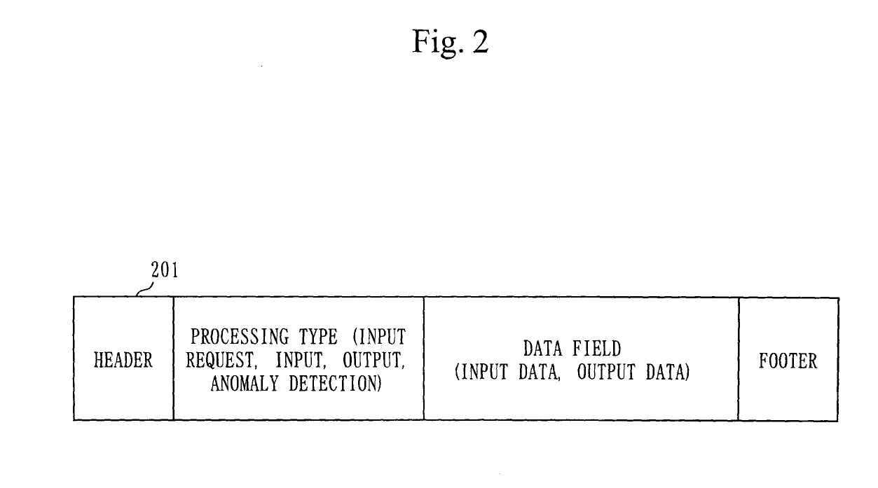

FIG. 2 illustrates an example of a communication frame 201 that is sent/received between the BCM 111 and the multiplex transmission apparatus 101.

In FIG. 2, a header and a footer are ones in accord with a protocol of the in-vehicle network 131.

Here, the header and footer include information to detect an error on the transmission of the in-vehicle network 131 such as a CRC (Cyclic Redundancy Check).

By such information for the error detection, besides an error that occurs on the in-vehicle network 131, the anomaly of the route related to the control of the BCM 111 can be detected.

In a column of processing type, an object of the communication frame 201 is shown.

More specifically, in the column of processing type, a value that represents “input request”, “input”, “output”, or “anomaly detection” is described.

“Input request” is written in the communication frame 201 used by the BCM 111 for requesting the input data from the I/O devices 121 to 123.

“Input” is written in the communication frame 201 used by the multiplex transmission apparatus 101 for sending the input data stored in the shared memory 102 to the BCM 111 in response to the input request from the BCM 111.

“Output” is written in the communication frame 201 used by the BCM 111 for sending the output data to the I/O devices 121 to 123.

“Anomaly detection” is written in the communication frame 201 used for requesting the transmission of the input data and the output data stored in the shared memory 112 of the BCM 111 for the anomaly detection, and in the communication frame 201 used by the BCM 111 for sending the input data and the output data stored in the shared memory 112.

In the data field, at least one of the input data and the output data is stored.

Subsequently, the operation of the in-vehicle network system of the first embodiment will be explained.

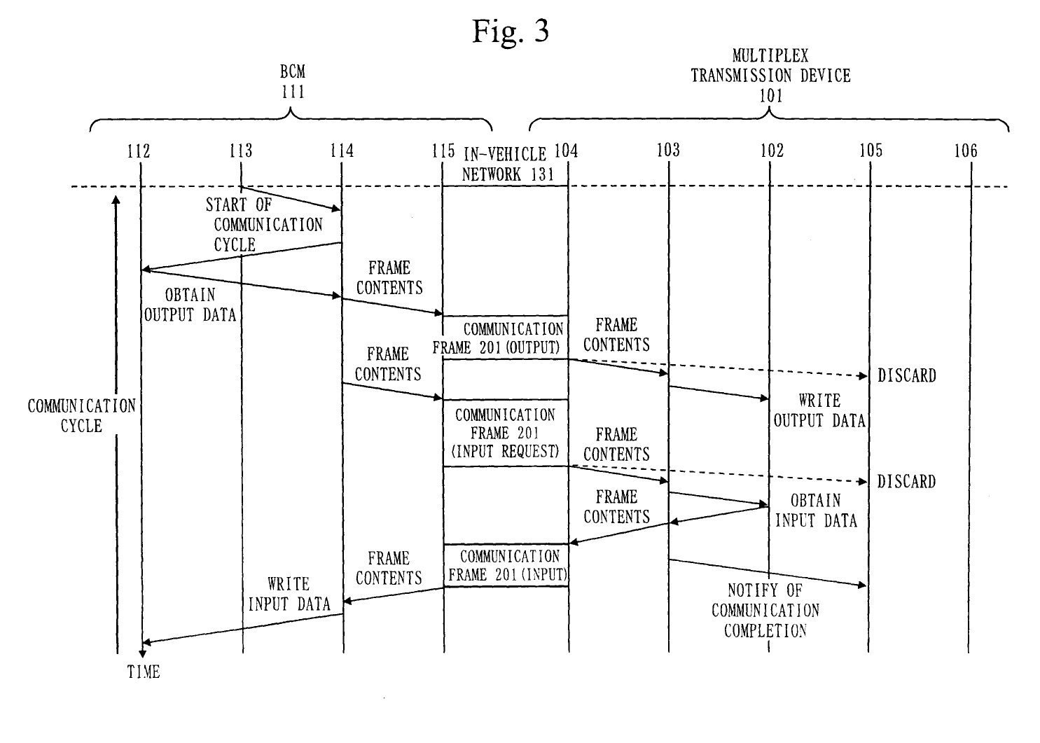

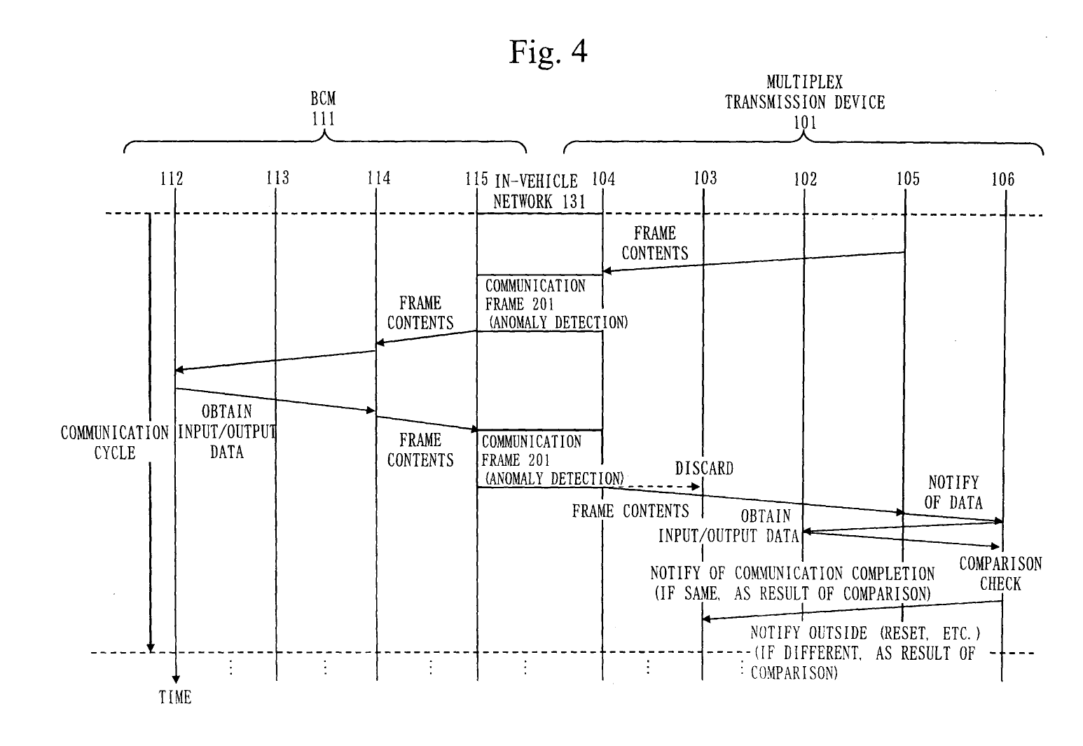

FIGS. 3 and 4 are diagrams illustrating an operation example of the in-vehicle network system of the first embodiment.

In FIGS. 3 and 4, a time axis is shown vertically from top to bottom, and each configurational component of the in-vehicle network system of the first embodiment is shown laterally.

FIGS. 3 and 4 illustrate dataflow over time among each of the configurational components.

Note that, in FIGS. 3 and 4, the description of the names of each element of the BCM 111 and the multiplex transmission apparatus 101 are omitted; only reference numerals are described, for the ease of drawing.

First, in the BCM 111, on receiving a signal showing the start of the communication cycle from the periodic communication timer 113, the periodic communication processing unit 114 obtains the output data to the I/O devices 121 to 123 from the shared memory 112.

Next, the periodic communication processing unit 114 outputs, to the communication unit 115, a value showing “output” as the value of processing type of the communication frame 201, and outputs the obtained output data as the value of data field to the communication unit 115.

Here, in the figure, the value of processing type and the value of data field are noted as the frame contents.

The communication unit 115 receives the value of processing type and the value of data field from the periodic communication processing unit 114.

Then, the communication unit 115 generates the communication frame 201 (output) using the value of processing type, the value of data field, the header, and the footer, and sends the generated communication frame 201 (output) to the in-vehicle network 131.

Next, in the multiplex transmission apparatus 101, the communication unit 104 receives the communication frame 201 (output) from the in-vehicle network 131.

Then, the communication unit 104 outputs the value of processing type (output) and the value of data field of the communication frame 201 (output) to the periodic communication processing unit 103.

Further, although the communication unit 104 outputs the value of processing type (output) and the value of data field of the communication frame 201 (output) also to the anomaly detection communication processing unit 105, the anomaly detection communication processing unit 105 discards the value of processing type (output) and the value of data field.

The periodic communication processing unit 103 receives the value of processing type (output) and the value of data field from the communication unit 104.

Next, the periodic communication processing unit 103 checks the processing type, and since the processing type is “output”, the periodic communication processing unit 103 writes the value of data field (output data) to the shared memory 102.

The output data written in the shared memory 102 is read out by the I/O devices 121 to 123.

Subsequently, in the BCM 111, the periodic communication processing unit 114 outputs the value showing “input request” as the value of processing type of the communication frame 201 to the communication unit 115, and outputs an arbitrary value as the value of data field of the communication frame 201 to the communication unit 115.

Here, the periodic communication processing unit 114 may specify, as the value of data field, the identifier of the input data obtained from the shared memory 102.

The communication unit 115 receives the value of processing type and the value of data field from the periodic communication processing unit 114.

Then, the communication unit 115 generates the communication frame 201 (input request) using the value of processing type, the value of data field, the header, and the footer, and sends the generated communication frame 201 (input request) to the in-vehicle network 131.

Next, in the multiplex transmission apparatus 101, the communication unit 104 receives the communication frame 201 (input request) from the in-vehicle network 131. Then, the communication unit 104 outputs the value of processing type (input request) and the value of data field of the communication frame 201 to the periodic communication processing unit 103.

Further, although the communication unit 104 outputs the value of processing type (input request) and the value of data field of the communication frame 201 also to the anomaly detection communication processing unit 105, the anomaly detection communication processing unit 105 discards the value of processing type (input request) and the value of data field.

The periodic communication processing unit 103 receives the value of processing type (input request) and the value of data field from the communication unit 104.

Next, the periodic communication processing unit 103 checks the processing type, and since the processing type is “input request”, the periodic communication processing unit 103 obtains the input data from the I/O devices 121 to 123 from the shared memory 102.

Then, the periodic communication processing unit 103 outputs the value showing “input” as the value of processing type of the communication frame 201 to the communication unit 104, and outputs the obtained input data as the value of data field to the communication unit 104.

The communication unit 104 receives the value of processing type and the value of data field from the periodic communication processing unit 103.

Then, the communication unit 104 generates the communication frame 201 (input) using the value of processing type, the value of data field, the header, and the footer, and sends the generated communication frame 201 (input) to the in-vehicle network 131.

Next, in the BCM 111, the communication unit 115 receives the communication frame 201 (input) from the in-vehicle network 131.

Then, the communication unit 115 outputs the value of processing type (input) and the value of data field of the communication frame 201 to the periodic communication processing unit 114.

The periodic communication processing unit 114 receives the value of processing type (input) and the value of data field from the communication unit 115.

Next, the periodic communication processing unit 114 checks the processing type, and since the processing type is “input”, the periodic communication processing unit 114 writes the value of data field (input data) to the shared memory 112.

On the other hand, the periodic communication processing unit 103 of the multiplex transmission apparatus 101 notifies the anomaly detection communication processing unit 105 of communication completion.

On receiving the communication completion notice from the periodic communication processing unit 103, the anomaly detection communication processing unit 105 outputs, as illustrated in FIG. 4, the value showing “anomaly detection” as the value of processing type of the communication frame 201 to the communication unit 104, and outputs an arbitrary value as the value of data field of the communication frame 201 to the communication unit 104.

The communication unit 104 receives the value of processing type and the value of data field from the anomaly detection communication processing unit 105.

Then, the communication unit 104 generates the communication frame 201 (anomaly detection) using the value of processing type, the value of data field, the header, and the footer, and sends the generated communication frame 201 (anomaly detection) to the in-vehicle network 131.

Next, in the BCM 111, the communication unit 115 receives the communication frame 201 (anomaly detection) from the in-vehicle network 131.

Then, the communication unit 115 outputs the value of processing type (anomaly detection) and the value of data field of the communication frame 201 to the periodic communication processing unit 114.

The periodic communication processing unit 114 receives the value of processing type (anomaly detection) and the value of data field from the communication unit 115.

Next, the periodic communication processing unit 114 checks the processing type, and since the processing type is “anomaly detection”, the periodic communication processing unit 114 obtains the input data and the output data from the shared memory 112.

Next, the periodic communication processing unit 114 outputs the value showing “anomaly detection” as the value of processing type of the communication frame 201 to the communication unit 115, and outputs the input data and the output data that have been obtained as the value of data field of the communication frame 201 to the communication unit 115.

The communication unit 115 receives the value of processing type and the value of data field from the periodic communication processing unit 114.

Then, the communication unit 115 generates the communication frame 201 (anomaly detection) using the value of processing type, the value of data field, the header, and the footer, and sends the generated communication frame 201 (anomaly detection) to the in-vehicle network 131.

Next, in the multiplex transmission apparatus 101, the communication unit 104 receives the communication frame 201 (anomaly detection) from the in-vehicle network 131.

Then, the communication unit 104 outputs the value of processing type (anomaly detection) and the value of data field of the communication frame 201 to the anomaly detection communication processing unit 105.

Further, although the communication unit 104 outputs the value of processing type (anomaly detection) and the value of data field of the communication frame 201 also to the periodic communication processing unit 103, the periodic communication processing unit 103 discards the value of processing type (anomaly detection) and the value of data field.

The anomaly detection communication processing unit 105 receives the value of processing type (anomaly detection) and the value of data field from the communication unit 104.

Then, the anomaly detection communication processing unit 105 outputs the value of data field to the anomaly detection checking unit 106.

The anomaly detection checking unit 106 receives the value of data field from the anomaly detection communication processing unit 105.

Then, the anomaly detection checking unit 106, while holding the value of data field (input data and output data) in the predetermined storage area, obtains the input data and the output data from the shared memory 102.

Then, the anomaly detection checking unit 106 compares the input value (the input data and the output data from the BCM 111) received from the anomaly detection communication processing unit 105 with the input data and the output data obtained from the shared memory 102.

As a result of comparison, if both of the input data, both of the output data are the same, the anomaly detection checking unit 106 notifies the periodic communication processing unit 103 of communication completion.

By this operation, the in-vehicle network system becomes standby state until the periodic communication of the next cycle.

On the other hand, as a result of comparison, if both of the input data or both of the output data are not the same, the anomaly detection checking unit 106 notifies the outside.

As a notice to the outside, for instance, the communication unit 104 outputs the communication frame to the in-vehicle network 131 to reset the BCM 111. Further, an exclusive line can be provided between the BCM 111 and the multiplex transmission apparatus 101, so that the exclusive line resets the BCM 111 to notify another apparatus located outside of the anomaly.

For instance, it is assumed that the value of the input data stored in the shared memory 102 of the multiplex transmission apparatus 101 is A, and the value of the input data sent from the BCM 111 with the communication frame 201 (anomaly detection) is B.

In this case, it is estimated that an anomaly occurs in the route between the communication unit 115 and the shared memory 112, and that the input data whose original value is A may be changed to the value B, in the BCM 111, on receiving the communication frame 201 (input) or sending the communication frame 201 (anomaly detection).

Similarly, it is assumed that the value of the output data stored in the shared memory 102 of the multiplex transmission apparatus 101 is C, and the value of the output data sent from the BCM 111 with the communication frame 201 (anomaly detection) is D.

In this case, it is estimated that an anomaly occurs in the route between the communication unit 115 and the shared memory 112, and that the output data whose original value is C may be changed to the value D, in the BCM 111, on sending the communication frame 201 (anomaly detection).

As has been discussed, in the present embodiment, from the multiplex transmission apparatus to the BCM, the communication frame for the anomaly detection is sent at a constant cycle, and in addition, from the BCM to the multiplex transmission apparatus, the input data and the output data stored in the shared memory is returned, and thereby the anomaly of the route related to the control inside the BCM can be detected.

Here, the present embodiment has explained an example in which the format of the communication frame 201 (anomaly detection) is common with the format of the communication frame 201 (input), the communication frame 201 (input request) and the communication frame 201 (output).

However, the format of the communication frame 201 (anomaly detection) may not be common with the format of the communication frame 201 (input), the communication frame 201 (input request) and the communication frame 201 (output).

Further, in the present embodiment, the multiplex transmission apparatus 101 receives the output data with the communication frame 201 (output) from the BCM 111, and the multiplex transmission apparatus 101 sends the input data with the communication frame 201 (input) to the BCM 111, then the multiplex transmission apparatus 101 sends the communication frame 201 (anomaly detection), and receives the output data and the input data stored in the shared memory 112 of the BCM 111.

Alternatively, after the multiplex transmission apparatus 101 receives the output data with the communication frame 201 (output) from the BCM 111, the multiplex transmission apparatus 101 may send the communication frame 201 (anomaly detection) and receive the output data in the shared memory 112 of the BCM 111; after the multiplex transmission apparatus 101 sends the input data with the communication frame 201 (input) to the BCM 111, the multiplex transmission apparatus 101 may send the communication frame 201 (anomaly detection) and receive the input data stored in the shared memory 112 of the BCM 111.

As discussed above, the present embodiment has explained the in-vehicle network system in which the BCM and the multiplex transmission apparatus are connected via the in-vehicle network.

Then, the BCM includes:

the communication unit which sends/receives the communication data to/from the in-vehicle network;

the shared memory which holds the input/output data from/to the I/O device;

the periodic communication timer which supplies a timing for transmission/reception with a constant cycle; and

the periodic communication processing unit which sends/receives to/from the multiplex transmission apparatus the input/output data from/to the I/O device held in the shared memory at a timing of the constant cycle generated by the periodic communication timer, and performs communication for the anomaly detection with the multiplex transmission apparatus, and

the multiplex transmission apparatus includes:

the communication unit which sends/receives the communication data to/from the in-vehicle network;

the shared memory which holds the input/output data from/to the I/O device and connects with the I/O device;

the periodic communication processing unit which sends/receives the input/output data from/to the I/O device held in the shared memory to/from the BCM;

the anomaly detection communication processing unit which sends/receives the communication frame for the anomaly detection to/from the BCM to perform the anomaly detection of the route related to the control of the BCM; and

the anomaly detection checking unit which performs the anomaly detection of the route related to the control of the BCM from the communication data for the anomaly detection returned from the BCM.

### Embodiment 2

The above first embodiment has explained the configuration in which the multiplex transmission apparatus sends with a constant cycle the communication frame having the same format with the format of the communication frame for controlling the I/O device to the BCM, for the anomaly detection, and in addition, from the BCM to the multiplex transmission apparatus, the input data and the output data are returned, so that anomaly of the route related to the control inside the BCM can be detected.

Next, the present embodiment will explain a configuration to detect an anomaly of a route related to the control inside the BCM using the communication frame which is broadcasted in a normal periodic communication.

According to the present embodiment, there is no need to sends/receives the communication frame for the anomaly detection with a constant cycle, which reduces the communication quantity of the in-vehicle network.

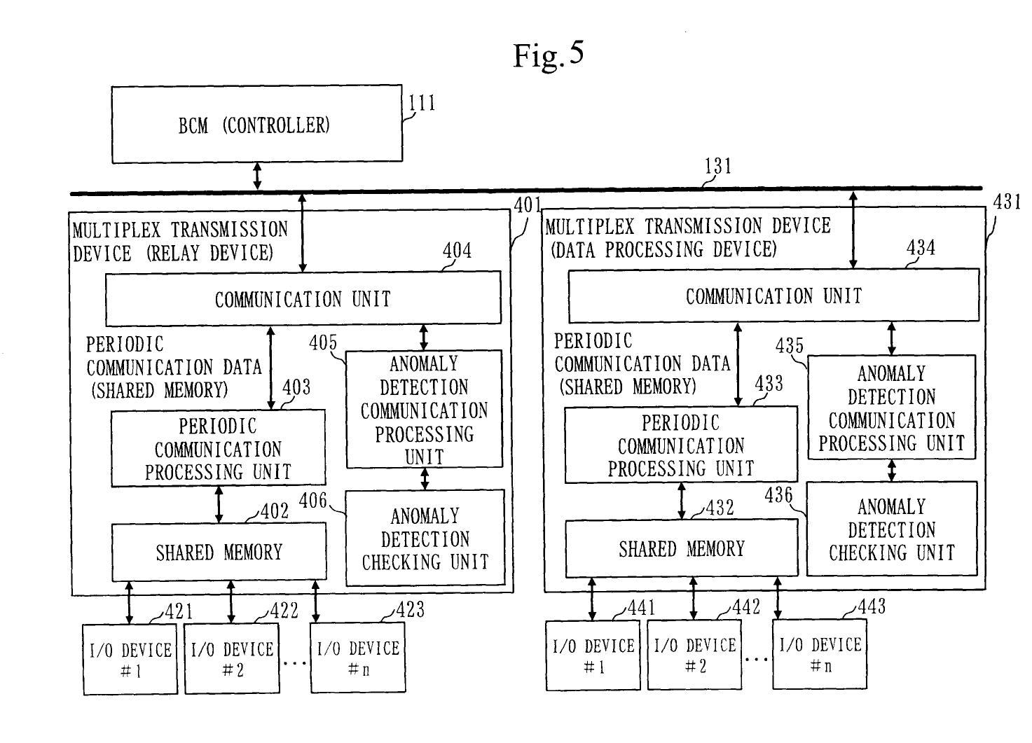

FIG. 5 is a diagram illustrating a configuration example of the in-vehicle network system of the second embodiment.

As illustrated in FIG. 5, in the in-vehicle network system according to the second embodiment, the BCM 111, a multiplex transmission apparatus 401 connecting I/O devices 421 to 423, and a multiplex transmission apparatus 431 connecting I/O devices 441 to 443 are mutually connected via the in-vehicle network 131.

The BCM 111 is the same with the one illustrated in FIG. 1.

Here, in FIG. 5, for the ease of drawing, the illustration of the internal configuration of the BCM 111 is omitted; however, the BCM 111 according to the present embodiment also has the same internal configuration with the one illustrated in FIG. 1.

The multiplex transmission apparatus 401 and the multiplex transmission apparatus 431 are the same with the multiplex transmission apparatus 101 illustrated in FIG. 1.

In the present embodiment, the multiplex transmission apparatus 401 and the BCM 111 broadcast a communication frame 501 (output), a communication frame 501 (input request) and a communication frame 501 (input), which will be discussed later.

Therefore, the multiplex transmission apparatus 431 can receive the communication frame 501 (output), the communication frame 501 (input request), and the communication frame 501 (input).

Then, the multiplex transmission apparatus 431 inspects whether or not the input data in the received communication frame 501 (input) and the output data in the received communication frame 501 (output) are matched with predetermined patterns of the input data and the output data.

If at least one of the input data and the output data is not matched with the patterns, that is, if at least one of the input data and the output data is anormal, the multiplex transmission apparatus 431 sends the communication frame 501 (anomaly detection) to the BCM 111, and makes the BCM 111 send the input data and the output data stored in the shared memory 112 of the BCM 111.

Then, the multiplex transmission apparatus 431 inspects whether or not the input data and the output data sent from the BCM 111 as a response to the communication frame 501 (anomaly detection), are matched with the patterns of the input data and the output data.

Further, the multiplex transmission apparatus 431 and the BCM 111 broadcast the communication frame 501 (output), the communication frame 501 (input request), and the communication frame 501 (input).

Therefore, the multiplex transmission apparatus 401 can receive the communication frame 501 (output), the communication frame 501 (input request), and the communication frame 501 (input).

The multiplex transmission apparatus 401 also inspects the input data and the output data similarly to the multiplex transmission apparatus 431.

In a case where the multiplex transmission apparatus 401 and the BCM 111 send/receive the communication frame, the multiplex transmission apparatus 401 corresponds to an example of a relay device, and the multiplex transmission apparatus 431 corresponds to an example of the data processing apparatus.

In a case where the multiplex transmission apparatus 431 and the BCM 111 send/receive the communication frame, the multiplex transmission apparatus 431 corresponds to an example of the relay device, and the multiplex transmission apparatus 401 corresponds to an example of the data processing apparatus.

In the multiplex transmission apparatus 401, the shared memory 402 is the same with the shared memory 102 illustrated in FIG. 1.

In the present embodiment, the shared memory 402 corresponds to an example of a storage unit.

The communication unit 404, similarly to the first embodiment, performs the periodic communication with the BCM 111.

The communication frame sent/received in the periodic communication is broadcasted as discussed above.

Further, the communication unit 404 receives the communication frame 501 broadcasted by the BCM 111 and the communication frame 501 broadcasted by the multiplex transmission apparatus 431.

Then, the communication unit 404 outputs the input data and the output data included in the received communication frame 501 to the periodic communication processing unit 403 and the anomaly detection communication processing unit 405, which will be discussed later.

The other operations of the communication unit 404 are the same with the ones of the communication unit 104 illustrated in FIG. 1.

Also in the present embodiment, the communication unit 404 corresponds to an example of the first communication unit and the second communication unit.

In addition, also in the present embodiment, the communication unit 404, as well as the anomaly detection communication processing unit 405, which will be discussed later, corresponds to an example of the message generation unit.

The periodic communication processing unit 403 receives the input data and the output data obtained from the communication frame 501 broadcasted by the BCM 111 and the communication frame 501 broadcasted by the multiplex transmission apparatus 431 that have been received by the communication unit 404, but discards the input data and the output data.

The other operations of the periodic communication processing unit 403 are the same with the ones of the periodic communication processing unit 103 illustrated in FIG. 1.

The anomaly detection communication processing unit 405 receives the input data and the output data obtained from the communication frame 501 broadcasted by the BCM 111 and the communication frame 501 broadcasted by the multiplex transmission apparatus 431 that have been received by the communication unit 404, and outputs the input data and the output data to the anomaly detection checking unit 406.

Further, the anomaly detection communication processing unit 405, when requested by the anomaly detection checking unit 406, generates a communication frame 501 for the anomaly detection (transmission request message).

The other operations of the anomaly detection communication processing unit 405 are the same with the ones of the anomaly detection communication processing unit 105 illustrated in FIG. 1.

Also in the present embodiment, the anomaly detection communication processing unit 405, as well as the communication unit 404, corresponds to an example of the message generation unit.

The anomaly detection checking unit 406 receives the output data and the input data from the anomaly detection communication processing unit 405, and stores the output data and the input data that have been received in a predetermined memory other than the shared memory 402.

Further, the anomaly detection checking unit 406 includes an input/output pattern table showing patterns of the input data and the output data of the I/O devices 421 to 423.

Then, the anomaly detection checking unit 406 inspects whether or not the output data and the input data stored in the memory are matched with the input/output pattern table.

In the present embodiment, the anomaly detection checking unit 406 corresponds to an example of the data inspecting unit.

The input/output pattern table is a table showing a combination of appropriate output data and input data, which corresponds to an example of the inspecting standard information.

The input/output pattern table is a table showing information, for instance, such that, in a proper sequence, after the output data of a type X is sent from the BCM 111, the input data of a type Y is sent to the BCM 111.

The input/output pattern table can be previously set in the anomaly detection checking unit 406, or before starting the periodic communication, at the time of initialization, the input/output pattern table can be set to the multiplex transmission apparatuses 401 and 431 from the BCM 111, or before starting the periodic communication, the input/output pattern table can be set between the multiplex transmission apparatuses 401 and 431 using the communication frame 501, which will be discussed later.

Further, the anomaly detection checking unit 406, if the output data and the input data stored in the memory are not matched with the input/output pattern table, requests the anomaly detection communication processing unit 405 to generate the communication frame 501 for the anomaly detection.

Then, the anomaly detection checking unit 406, when receiving the output data and the input data stored in the shared memory 112 of the BCM 111 from the BCM 111, inspects whether or not the output data and the input data received from the BCM 111 are matched with the input/output pattern table.

The I/O devices 421 to 423 and the I/O devices 441 to 443 are the same with the I/O devices 121 to 123 illustrated in FIG. 1.

The shared memory 432 is the same with the shared memory 402.

The periodic communication processing unit 433 is the same with the periodic communication processing unit 403.

The communication unit 434 is the same with the communication unit 404.

The anomaly detection communication processing unit 435 is the same with the anomaly detection communication processing unit 405.

The anomaly detection checking unit 436 is the same with the anomaly detection checking unit 406.

Next, the format of the communication frame used in the in-vehicle network system according to the second embodiment will be explained.

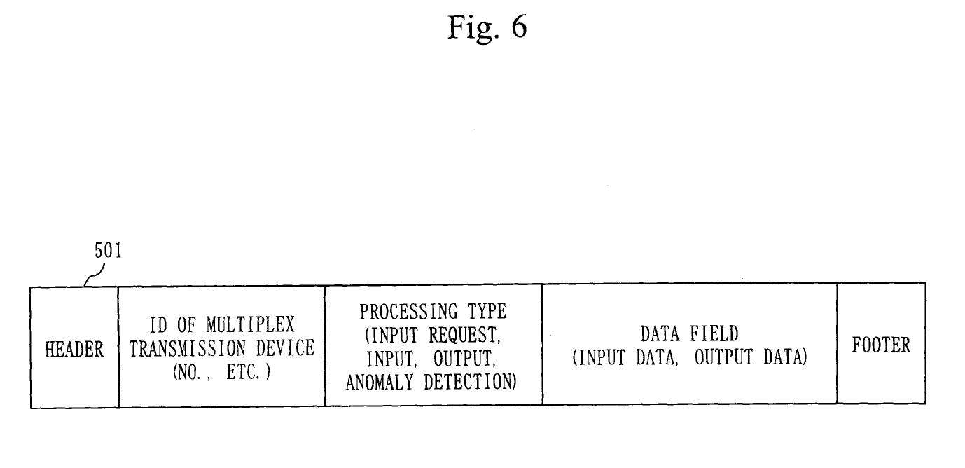

FIG. 6 illustrates the communication frame 501 which is sent/received between the BCM 411 and the multiplex transmission apparatuses 401 and 431.

Since the header, the processing type, the data field, and the footer are the same with the ones illustrated in FIG. 2, the explanation will be omitted.

To the communication frame 501, compared with the communication frame 201, the identifier of the multiplex transmission apparatus is added.

To the identifier of the multiplex transmission apparatus, the identifiers such as the numbers of the multiplex transmission apparatuses 401 and 431 are set.

Subsequently, the operation of the in-vehicle network system according to the second embodiment will be explained.

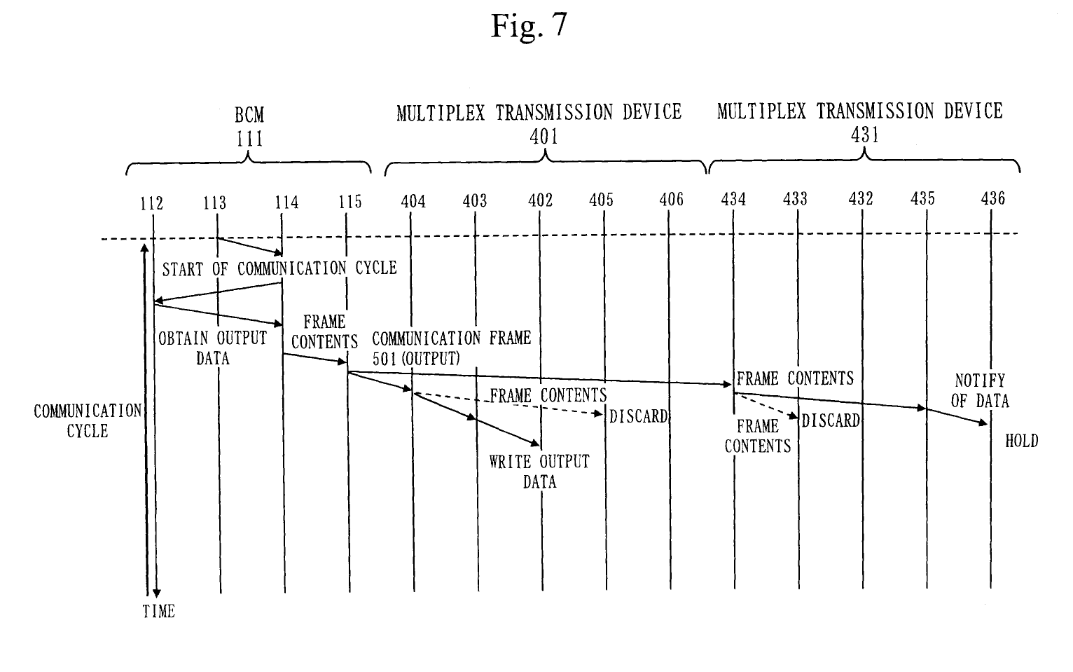

FIGS. 7 to 10 are diagrams illustrating an operation example of the in-vehicle network system according to the second embodiment.

Similarly to FIGS. 3 and 4, also in FIGS. 7 to 10, a time axis is shown vertically from top to bottom, and each configurational component of the in-vehicle network system of the second embodiment is shown laterally.

Similarly to FIGS. 3 and 4, also FIGS. 7 to 10 illustrate dataflow over time among each of the configurational components.

Further, also in FIGS. 7 to 10, similarly to FIGS. 3 and 4, for the ease of drawing, the description of the names of each element of the BCM 111 and the multiplex transmission apparatus 101 are omitted; only reference numerals are described.

First, as illustrated in FIG. 7, in the BCM 111, the periodic communication processing unit 114, on receiving a signal showing the start of the communication cycle from the periodic communication timer 113, obtains the output data to the I/O devices 121 to 123 from the shared memory 112.

Next, the periodic communication processing unit 114 outputs the identifier of the multiplex transmission apparatus 401 to the communication unit 115 as the identifier of the multiplex transmission apparatus of the communication frame 501, outputs the value showing “output” as the value of processing type of the multiplex transmission apparatus of the communication frame 501, and outputs the obtained output data as the value of data field of the multiplex transmission apparatus of the communication frame 501.

Here, in the figure, the identifier of the multiplex transmission apparatus, the value of processing type, and the value of data field are described as frame contents.

The communication unit 115 receives the identifier of the multiplex transmission apparatus and the value of processing type and the value of data field from the periodic communication processing unit 114.

Then, the communication unit 115 generates the communication frame 501 (output) using the identifier of the multiplex transmission apparatus, the value of processing type, the value of data field, the header, and the footer, and broadcasts the generated communication frame 501 (output) to the in-vehicle network 131.

The communication frame 501 (output) is received by the multiplex transmission apparatus 401 and the multiplex transmission apparatus 431.

In the multiplex transmission apparatus 401, the communication unit 404 receives the communication frame 501 (output) from the in-vehicle network 131.

Then, the communication unit 404 outputs the identifier of the multiplex transmission apparatus, the value of processing type (output), and the value of data field of the communication frame 501 to the periodic communication processing unit 403.

Further, although the communication unit 404 outputs the identifier of the multiplex transmission apparatus, the value of processing type (output), and the value of data field of the communication frame 501 also to the anomaly detection communication processing unit 405, the anomaly detection communication processing unit 405 discards the identifier of the multiplex transmission apparatus, the value of processing type (output), and the value of data field.

The periodic communication processing unit 403 receives the identifier of the multiplex transmission apparatus, the value of processing type (output), and the value of data field from the communication unit 404/

Next, the periodic communication processing unit 403 checks the identifier of the multiplex transmission apparatus and the processing type, and since the data is to be destined for the apparatus of its own, and the processing type is “output”, the periodic communication processing unit 403 writes the value of data field (output data) in the shared memory 402.

The output data written in the shared memory 402 is read out by the I/O devices 421 to 423.

In the multiplex transmission apparatus 431, the communication unit 434 receives the communication frame 501 (output) from the in-vehicle network 131.

Then, the communication unit 434 outputs the identifier of the multiplex transmission apparatus, the value of processing type (output), and the value of data field of the communication frame 501 to the anomaly detection communication processing unit 435.

Further, although since the communication unit 434 outputs the identifier of the multiplex transmission apparatus, the value of processing type (output), and the value of data field of the communication frame 501 also to the periodic communication processing unit 433, the periodic communication processing unit 433 checks the identifier of the multiplex transmission apparatus, and since the data is destined for another multiplex transmission apparatus, the periodic communication processing unit 433 discards the identifier of the multiplex transmission apparatus, the value of processing type (output), and the value of data field.

The anomaly detection communication processing unit 435 receives the identifier of the multiplex transmission apparatus, the value of processing type (output), and the value of data field from the communication unit 434.

Then, the anomaly detection communication processing unit 435 checks the identifier of the multiplex transmission apparatus and the processing type, and since the data is destined for another multiplex transmission apparatus, the anomaly detection communication processing unit 435 outputs the value of data field to the anomaly detection checking unit 436.

The anomaly detection checking unit 436 receives the value of data field from the anomaly detection communication processing unit 435.

Then, the anomaly detection checking unit 436 stores the received value of data field (output data) in the predetermined memory.

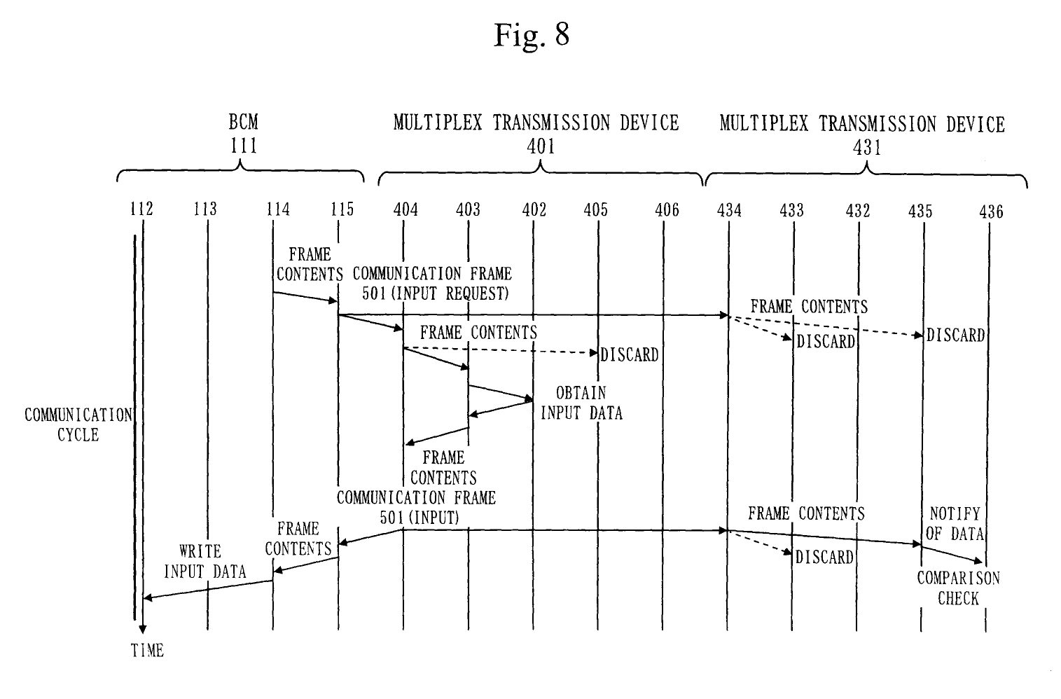

Subsequently, in FIG. 8, in the BCM 111, the periodic communication processing unit 114 outputs the identifier of the multiplex transmission apparatus 401 as the identifier of the multiplex transmission apparatus of the communication frame 501 to the communication unit 115, and outputs the value showing “input request” as the value of processing type of the communication frame 501 to the communication unit 115, and outputs an arbitrary value as the value of data field of the communication frame 501 to the communication unit 115.

Here, the periodic communication processing unit 114 may specify, as the value of data field, the identifier of the input data obtained from the shared memory 402.

The communication unit 115 receives the identifier of the multiplex transmission apparatus, the processing type, and the value of data field from the periodic communication processing unit 114.

Then, the communication unit 115 generates the communication frame 501 (input request) using the identifier of the multiplex transmission apparatus, the value of processing type, the value of data field, the header, and the footer, and broadcasts the generated communication frame 501 (input request) to the in-vehicle network 131.

The communication frame 501 (input request) is received by the multiplex transmission apparatus 401 and the multiplex transmission apparatus 431.

To the multiplex transmission apparatus 431, the communication frame 501(input request) is unnecessary data.

The communication unit 434 receives the communication frame 501 (input request), and the identifier of the multiplex transmission apparatus, the processing type (input request), and the value of data field within the communication frame 501 (input request) are output from the communication unit 434 to the periodic communication processing unit 433 and the anomaly detection communication processing unit 435. The periodic communication processing unit 433 and the anomaly detection communication processing unit 435 check the identifier of the multiplex transmission apparatus and the processing type, and discards the identifier of the multiplex transmission apparatus, the processing type (input request), and the value of data field.

In the multiplex transmission apparatus 401, the communication unit 404 receives the communication frame 501 (input request) from the in-vehicle network 131.

Then, the communication unit 404 outputs the identifier of the multiplex transmission apparatus, the value of processing type (input request), and the value of data field of the communication frame 501 to the periodic communication processing unit 403.

Further, although the communication unit 404 outputs the identifier of the multiplex transmission apparatus, the value of processing type (input request), and the value of data field of the communication frame 501 also to the anomaly detection communication processing unit 405, the anomaly detection communication processing unit 405 discards the identifier of the multiplex transmission apparatus, the value of processing type (input request), and the value of data field.

The periodic communication processing unit 403 receives the identifier of the multiplex transmission apparatus, the value of processing type (input request), and the value of data field from the communication unit 404.

Next, the periodic communication processing unit 403 checks the identifier of the multiplex transmission apparatus and the processing type, and since the data is destined for the apparatus of its own, and the processing type is “input request”, the periodic communication processing unit 403 obtains from the shared memory 402 the input data from the I/O devices 421 to 423.

Then, the periodic communication processing unit 403 outputs the identifier of the multiplex transmission apparatus 401 as the identifier of the multiplex transmission apparatus of the communication frame 501 to the communication unit 404, and outputs the value showing “input” as the value of processing type of the communication frame 501 to the communication unit 404, and outputs the obtained input data as the value of data field of the communication frame 501 to the communication unit 404.

The communication unit 404 receives the identifier of the multiplex transmission apparatus, the value of processing type, and the value of data field from the periodic communication processing unit 403.

Then, the communication unit 404 generates the communication frame 501 (input) using the identifier of the multiplex transmission apparatus, the value of processing type, the value of data field, the header, and the footer, and broadcasts the generated communication frame 501 (input) to the in-vehicle network 131.

The communication frame 501 (input) is received by the BCM 111 and the multiplex transmission apparatus 431.

First, in the BCM 111, the communication unit 115 receives the communication frame 501 (input) from the in-vehicle network 131.

Then, the communication unit 115 outputs the identifier of the multiplex transmission apparatus, the value of processing type (input), and the value of data field of the communication frame 501 to the periodic communication processing unit 114.

The periodic communication processing unit 114 receives the identifier of the multiplex transmission apparatus, the value of processing type (input), and the value of data field from the communication unit 115.

Next, the periodic communication processing unit 114 checks the processing type, and since the processing type is “input”, the periodic communication processing unit 114 writes the value of data field (input data) in an area for the multiplex transmission apparatus 401 in the shared memory 112.

Next, in the multiplex transmission apparatus 431, the communication unit 434 receives the communication frame 501 (input) from the in-vehicle network 131.

Then, the communication unit 434 outputs the identifier of the multiplex transmission apparatus, the value of processing type (input), and the value of data field of the communication frame 501 to the anomaly detection communication processing unit 435.

Further, although the communication unit 434 outputs the identifier of the multiplex transmission apparatus, the value of processing type (input), and the value of data field of the communication frame 501 also to the periodic communication processing unit 433. The periodic communication processing unit 433 checks the identifier of the multiplex transmission apparatus, and since the data is destined for the BCM 111, the periodic communication processing unit 433 discards the identifier of the multiplex transmission apparatus, the value of processing type (input), and the value of data field.

The anomaly detection communication processing unit 435 receives the identifier of the multiplex transmission apparatus, the value of processing type (input), and the value of data field from the communication unit 434.

Then, the anomaly detection communication processing unit 435 checks the identifier of the multiplex transmission apparatus and the processing type, and since the data is destined for the BCM 111, the anomaly detection communication processing unit 435 outputs the value of data field to the anomaly detection checking unit 436.

The anomaly detection checking unit 436 receives the value of data field from the anomaly detection communication processing unit 435.

Next, the anomaly detection checking unit 436 compares the value of data field (input data) received from the anomaly detection communication processing unit 435 and the output data held in the memory with the input/output pattern table to check the presence/absence of the anomaly.

As a result of comparison, if the input data that have been received and the output data are matched with the input/output pattern table, the anomaly detection checking unit 436 does not do anything.

On the other hand, if the input data that have been received and the output data are not matched with the input/output pattern table, at least one of the input data that have been received and the output data includes the anomaly, and the anomaly detection checking unit 436 requests the anomaly detection communication processing unit 435 to generate the communication frame 501 (anomaly detection).

The subsequent operations are similar to the first embodiment.

Then, the anomaly detection checking unit 436 receives the value of data field (the input data and the output data stored in the shared memory 112 of the BCM 111) of the communication frame 501 (anomaly detection) from the BCM 111.

The anomaly detection checking unit 436 compares the received value of data field (the input data and the output data stored in the shared memory 112 of the BCM 111) with the input/output pattern table.

As a result of comparison, if the input data and the output data which are the values of received data field are matched with the input/output pattern table, the anomaly detection checking unit 436 does not do anything.

On the other hand, if the input data and the output data which are the values of received data field are different from the input/output pattern table, the anomaly detection checking unit 436 notifies the outside.

As a notice to the outside, for instance, the communication unit 434 outputs the communication frame to the in-vehicle network 131 to reset the BCM 111. Further, an exclusive line is provided between the BCM 111 and the multiplex transmission apparatus 431, and the BCM 111 can be reset by the exclusive line and the other apparatuses can be notified of the anomaly.

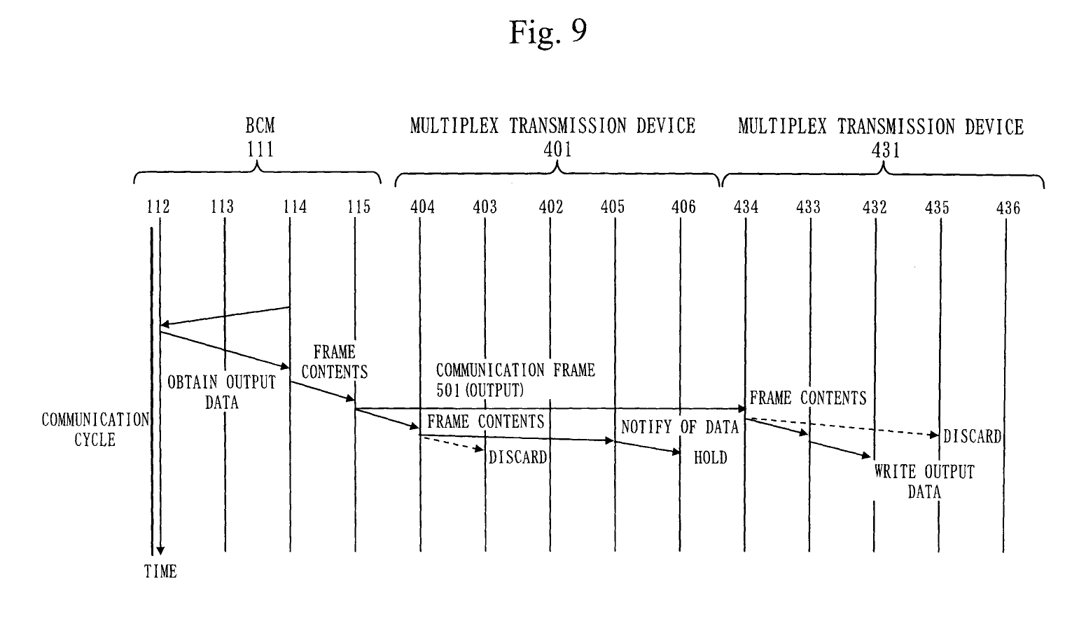

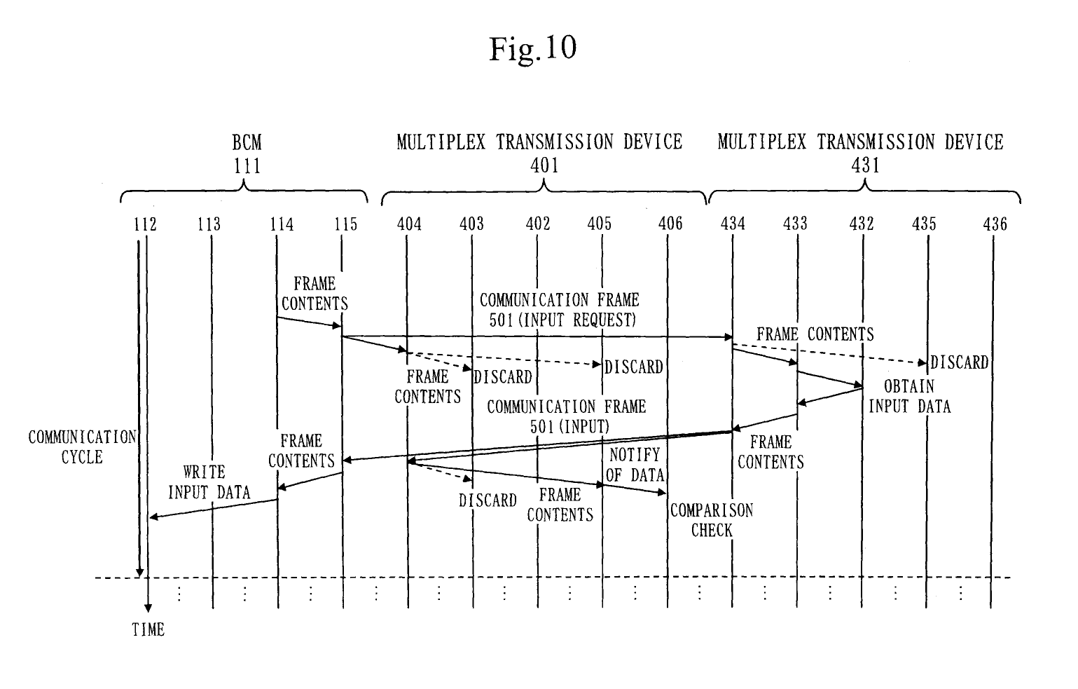

Subsequently, a periodic communication is performed between the BCM 111 and the multiplex transmission apparatus 431 (FIG. 9, FIG. 10).

The process of the periodic communication is the same with the above process of the periodic communication between the BCM 111 and the multiplex transmission apparatus 401, and further, the process related to the anomaly detection performed by the multiplex transmission apparatus 401 is the same with the process of the above multiplex transmission apparatus 431.

As has been discussed, in the present embodiment, the communication frame broadcasted in a normal periodic communication is used to perform the anomaly detection of the route related to the control inside the BCM, so that the anomaly of the route related to the control inside the BCM can be detected without sending/receiving the communication frame for the anomaly detection for each cycle.

Then, since the communication frame for the anomaly detection is not sent/received for each cycle, the communication quantity of the in-vehicle network can be reduced.

As discussed above, the present embodiment has explained the in-vehicle network system in which the BCM and the plurality of multiplex transmission apparatuses are connected via the in-vehicle network.

Then, it has been explained that each of the multiplex transmission apparatuses includes:

the communication unit which sends/receives the communication data to/from the in-vehicle network;

the shared memory which holds the input/output data from/to the I/O device;

the periodic communication processing unit which sends/receives the input/output data from/to the I/O device held in the shared memory to/from the BCM;

the anomaly detection communication processing unit which sends/receives the communication frame for the anomaly detection used for the anomaly detection in the route related to the control of the BCM to/from the BCM; and

the anomaly detection checking unit which includes correspondence of the input/output pattern of the I/O device connected to the other multiplex transmission apparatus as a table.

### Embodiment 3

In the second embodiment, to the multiplex transmission apparatus 431, the I/O devices 441 to 443 are connected, and thereby the multiplex transmission apparatus 431 receives the output data to be sent to the I/O devices 441 to 443 from the BCM 111, and further, sends the input data from the I/O devices 441 to 443 to the BCM 111 (FIG. 9, FIG. 10).

Alternatively, in the present embodiment, the multiplex transmission apparatus 431 is used as a back-up apparatus for the multiplex transmission apparatus 401.

That is, in the present embodiment, the multiplex transmission apparatus 431 is not provided with the I/O devices 441 to 443, and further, the multiplex transmission apparatus 431 does not receive the output data nor send the input data as illustrated in FIGS. 9 and 10.

The multiplex transmission apparatus 431, in a case where a fault occurs in the multiplex transmission apparatus 401, in the place of the multiplex transmission apparatus 401, sends the communication frame 201 (anomaly detection) which has been explained in the first embodiment to the BCM 111.

The configuration of the in-vehicle network system related to the present embodiment is the configuration of FIG. 5 with eliminating the I/O devices 441 to 443.

Here, in the present embodiment, the anomaly detection checking unit 436 of the multiplex transmission apparatus 431 corresponds to an example of the data comparison unit.

In the present embodiment, the BCM 111 broadcasts the communication frame 201 (output) and the communication frame 201 (input request) which have been explained in the first embodiment.

Further, the multiplex transmission apparatus 401 broadcasts the communication frame 201 (input) which has been explained in the first embodiment.

In addition, the multiplex transmission apparatus 401 broadcasts the communication frame 201 (anomaly detection) which has been explained in the first embodiment.

Further, in response to the communication frame 201 (anomaly detection) from the multiplex transmission apparatus 401, the BCM 111 broadcasts the input data and the output data stored in the shared memory 112.

The multiplex transmission apparatus 431 stores the output data included in the communication frame 201 (output) and the input data included in the communication frame 201 (input) in, for instance, the shared memory 432.

Then, after receiving the communication frame 201 (input) broadcasted from the multiplex transmission apparatus 401, if the anomaly detection communication processing unit 435 does not receive the communication frame 201 (anomaly detection) from the multiplex transmission apparatus 401, the anomaly detection communication processing unit 435 generates the communication frame 201 (anomaly detection) instead of the multiplex transmission apparatus 401

The communication frame 201 (anomaly detection) corresponds to an example of an alternative transmission request message.

Then, the communication unit 434 broadcasts the communication frame 201 (anomaly detection) generated by the anomaly detection communication processing unit 435.

The BCM 111 receives the communication frame 201 (anomaly detection) from the multiplex transmission apparatus 431, and broadcasts the input data and the output data stored in the shared memory 112.

In the multiplex transmission apparatus 431, the anomaly detection checking unit 436 compares, similarly to the first embodiment, the input data and the output data received from the BCM 111 with the input data and the output data stored in the shared memory 432.

The subsequent operation is the same with the one of the anomaly detection checking unit 106 according to the first embodiment.

As discussed above, the present embodiment has explained the in-vehicle network system in which the BCM and the plurality of multiplex transmission apparatuses are connected via the in-vehicle network.

Then, it has been explained that one of the plurality of multiplex apparatuses backs up other multiplex transmission apparatuses, and at the time of normal periodic communication, monitors the communication frame for the anomaly detection sent from the other multiplex transmission apparatus, and when the communication frame for the anomaly detection cannot be detected, the multiplex apparatus acts for the communication for anomaly detection.

Embodiments of the present invention have been explained above; among these embodiments, two or more embodiments may be combined and implemented.

Or, among these embodiments, one embodiment may be implemented partially.

Or, among these embodiments, two or more embodiments may be partially combined and implemented.

Here, the present invention is not limited to these embodiments, but can vary according to the necessity.

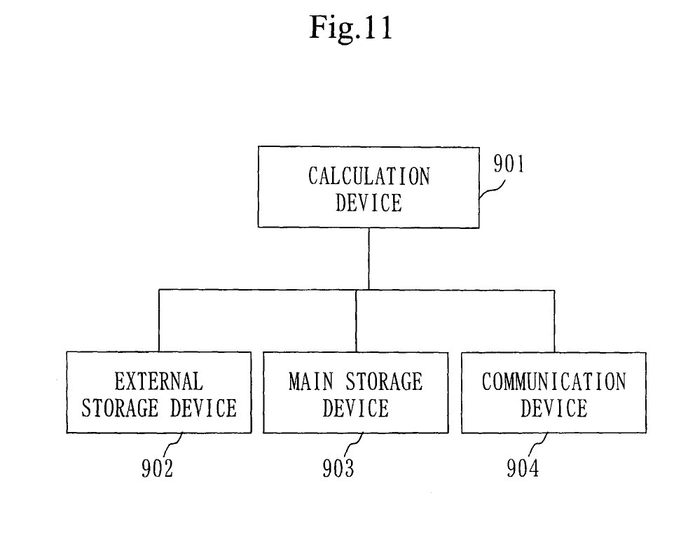

Finally, a hardware configuration example of the BCM 111 and the multiplex transmission apparatus 101 (the multiplex transmission apparatus 401, the multiplex transmission apparatus 431) shown in the first to third embodiments will be explained with reference to FIG. 11.

The BCM 111 and the multiplex transmission apparatus 101 (the multiplex transmission apparatus 401, the multiplex transmission apparatus 431) are computers, and each element of the BCM 111 and the multiplex transmission apparatus 101 (the multiplex transmission apparatus 401, the multiplex transmission apparatus 431) can be implemented by the programs.

As a hardware configuration of the BCM 111 and the multiplex transmission apparatus 101 (the multiplex transmission apparatus 401, the multiplex transmission apparatus 431), to a bus, a calculation device 901, an external storage device 902, a main storage device 903, and a communication device 904 are connected.

The calculation device 901 is a CPU which executes the programs.

The external storage device 902 is, for instance, a ROM (Read Only Memory) or a flash memory.

The main storage device 903 is a RAM (Random Access Memory).

The communication device 904 corresponds to the communication unit 115, the communication unit 104 (the communication unit 404, the communication unit 434).

The programs are usually stored in the external storage device 902, with being loaded to the main storage device 903, and sequentially read and executed by the calculation device 901.

The programs are to implement functions explained as “unit” (except for the communication unit, the same can be applied hereinafter) illustrated in FIG. 1 and FIG. 5.

Further, information, data, signal values, and variable values showing results of the processing that have been explained as “determination”, “check”, “extraction”, “detection”, “setting”, “registration”, “selection”, “generation”, “input”, “output”, and the like in the first to third embodiments are stored as files in the main storage device 903.

Here, the configuration of FIG. 11 merely shows an example of hardware configuration of the BCM 111 and the multiplex transmission apparatus 101 (the multiplex transmission apparatus 401, the multiplex transmission apparatus 431); and the hardware configuration of the BCM 111 and the multiplex transmission apparatus 101 (the multiplex transmission apparatus 401, the multiplex transmission apparatus 431) is not limited to the configuration shown in FIG. 11 but can be another configuration.

### REFERENCE SIGNS LIST

101: multiplex transmission apparatus; 102: shared memory; 103: periodic communication processing unit; 104: communication unit; 105: anomaly detection communication processing unit; 106: anomaly detection checking unit; 111: BCM; 112: shared memory; 113: periodic communication timer; 114: periodic communication processing unit; 115: communication unit; 121: I/O device; 122: I/O device; 123: I/O device; 131: in-vehicle network; 401: multiplex transmission apparatus; 402: shared memory; 403: periodic communication processing unit; 404: communication unit; 405: anomaly detection communication processing unit; 406: anomaly detection checking unit; 431: multiplex transmission apparatus; 432: shared memory; 433: periodic communication processing unit; 434: communication unit; 435: anomaly detection communication processing unit; 436: anomaly detection checking unit; 421: I/O device; 422: I/O device; 423: I/O device; 441: I/O device; 442: I/O device; and 443: I/O device.

1-11. (canceled)

12. A data processing apparatus included in a communication system having a controller, a device controlled by the controller, and a relay device relaying the controller and the device, the data processing apparatus comprising:
a first communication circuit which receives control data which is data from the controller to the device broadcasted by the controller, and receives device data which is data from the device to the controller broadcasted by the relay device;
a storage circuit which stores the control data and the device data received by the first communication circuit; and
a data inspecting circuit which inspects the control data and the device data stored in the storage circuit.

13. The data processing apparatus of claim 12, wherein
the data inspecting circuit holds inspecting standard information showing a combination of appropriate control data and device data, and inspects whether or not the control data and the device data stored in the storage circuit are matched with the combination of appropriate control data and device data shown in the inspecting standard information.

14. The data processing apparatus of claim 13, further comprising:
a message generation circuit, if the data inspecting circuit determines the control data and the device data stored in the storage circuit are not matched with the combination of appropriate control data and device data shown in the inspecting standard information, which generates a transmission request message to request the controller to send the control data and the device data held in the controller; and
a second communication circuit which sends the transmission request message to the controller, and receives, as a response to the transmission request message, the control data and the device data held in the controller from the controller,
wherein the data inspecting circuit inspects whether or not the control data and the device data received by the second communication circuit are matched with the combination of appropriate control data and device data shown in the inspecting standard information.

15. The data processing apparatus of claim 14, wherein
the message generation circuit generates the transmission request message in a data format being same with the control data and the device data.

16. The data processing apparatus of claim 12, wherein
the data processing apparatus is a multiplex transmission apparatus included in an in-vehicle network system having a BCM (Body Control Module) as the controller and an I/O (Input/Output) device as the device.

17. A data processing apparatus included in a communication system having a controller, a device controlled by the controller, and a relay device relaying the controller and the device, the data processing apparatus comprising:
a first communication circuit which receives control data which is data from the controller to the device broadcasted by the controller, and receives device data which is data from the device to the controller broadcasted by the relay device;
a storage circuit which stores the control data and the device data received by the first communication circuit;
a message generation circuit which generates an alternative transmission request message to request to send the control data and the device data held in the controller, if the first communication circuit does not receive a transmission request message to request to send the control data and the device data held in the controller to the relay device, the transmission request message being broadcasted from the relay device, after the first communication circuit receives the control data and the device data;
a second communication circuit which sends the alternative transmission request message to the controller, and, as a response to the alternative transmission request message, receives the control data and the device data held in the controller from the controller; and
a data comparison circuit which compares the control data received by the second communication circuit with the control data stored in the storage circuit, and compares the device data received by the second communication circuit with the device data stored in the storage circuit.

18. A communication system comprising a controller, a device controlled by the controller, and a relay device relaying the controller and the device, and a data processing apparatus,
wherein the data processing apparatus includes:
a first communication circuit which receives control data which is data from the controller to the device broadcasted by the controller, and receives device data which is data from the device to the controller broadcasted by the relay device;
a storage circuit which stores the control data and the device data received by the first communication circuit; and
a data inspecting circuit which inspects the control data and the device data stored in the storage circuit.

19. A communication system comprising a controller, a device controlled by the controller, and a relay device relaying the controller and the device, and a data processing apparatus,
wherein the data processing apparatus includes:
a first communication circuit which receives control data which is data from the controller to the device broadcasted by the controller, and receives device data which is data from the device to the controller broadcasted by the relay device;
a storage circuit which stores the control data and the device data received by the first communication circuit;
a message generation circuit which generates an alternative transmission request message to request to send the control data and the device data held in the controller, if the first communication circuit does not receive a transmission request message to request to send the control data and the device data held in the controller to the relay device, the transmission request message being broadcasted from the relay device, after the first communication circuit receives the control data and the device data;
a second communication circuit which sends the alternative transmission request message to the controller, and, as a response to the alternative transmission request message, receives the control data and the device data held in the controller from the controller; and
a data comparison circuit which compares the control data received by the second communication circuit with the control data stored in the storage circuit, and compares the device data received by the second communication circuit with the device data stored in the storage circuit.
